(19) United States
(12) Patent Application Publication
(10) Pub. No.: US 2005/0225826 A1
(43) Pub. Date: Oct. 13, 2005

(54) Electroabsorption modulator biasing

(75) Inventor: John A. Krawczak, Minnetonka, MN (US)

Correspondence Address: E. J. Brooks & Associates, PLLC, Suite 500, 1221 Nicollet Avenue, Minneapolis, MN, 55403, US

(73) Assignee: Lockheed Martin Corporation

(21) Appl. No.: 10/822,430

(22) Filed: Apr. 12, 2004

(51) Int. Cl. G11B 7/00; G02F 1/01; G02B 26/00

(52) U.S. Cl. 359/239; 359/241

(57) ABSTRACT

Methods, systems, and devices are provided for transmitting an optical beam. One method embodiment includes modulating an optical beam to encode information through use of an electroabsorption modulator (EAM). The method also includes monitoring the encoded optical beam to measure a harmonic value. Upon detection of the harmonic value, an electrical input provided to the EAM is adjusted based upon the measured harmonic value.

### BACKGROUND

In order to transmit information across an optical fiber or other suitable medium, such as through free space, the information is encoded onto an optical beam generated by a light source, such as a laser. Once encoded, the information can be transmitted, typically as a series of on/off light pulses, or as a continuous light beam having areas of different intensity. The encoded information travels through the optical fiber to a destination where the information in the optical beam can be decoded.

The task of encoding the information into an optical beam is typically accomplished either by directly manipulating the light source, such as by varying the intensity of the light source, or by using one or more modulators, which are optical devices that can act as electrically controlled switches or irises. That is, a modulator can act as an iris to change the intensity of the light beam (i.e., amount of light) passing through the modulator to various intensity levels. This type of modulation is often used in transmitting analog information. A modulator can also act as a shutter to control the intensity of the beam by changing the intensity between two intensity levels, such as by turning the beam of light on and off. These types of modulators are often used in transmitting digital information.

Analog techniques for modulation include intensity modulation, amplitude modulation, frequency modulation, and phase modulation, among others. Digital techniques include on-off keying, amplitude shift keying, frequency shift keying, and phase shift keying, among others, as such terms are known and understood in the art.

There are several factors that determine the performance of a modulator, such as, bandwidth, modulator drive, and chirp, to name a few. Bandwidth refers to the number of times that the modulator can effectively perform a change through its entire light beam intensity range during a period of time. In the field of optical signaling, bandwidth can be measured in gigahertz (GHz). One gigahertz is equivalent to 1 billion operations per second. Therefore, a 40 GHz modulator, for example, can perform a change in intensity operation 40 billion times in 1 second.

Modulator drive refers to the electrical voltage or current required to actuate the modulator to change the intensity of the light beam. The more electrically efficient a modulator is, the smaller the modulator drive value required to actuate the modulator. The amount of modulator drive required by the modulator is generally dictated by the design objectives proposed for the modulator and the characteristics of the material that is being used by a modulator to electrically control the change in the light beam, or to control the light source. Factors that affect the amount of modulator drive include modulator design objectives, ambient temperature around the material, the temperature of the material due to temperature changes generated by the modulator and/or other system components, and the age of the material, to name a few.

Chirp is characterized as variations in the light source's amplitude and frequency when the intensity of the light beam is modulated which produces distortion of the light signal as the light propagates through the fiber or other medium. This and other forms of distortion limit the efficiency of the optical transmission system.

As stated above, in some systems, modulation of the light beam can be achieved by changing the intensity of the light beam generated by the light source, thereby, directly modulating the signal by controlling the light source. This technique can produce substantial amounts of chirp. Other systems use an external modulator which modulates the light coming out of the light source. Although these types of devices are referred to as external modulators, they can be integrated within the same substrate or module that is used to form the light source. External modulators are advantageous because, since the light source is not directly adjusted to modulate the light beam, the amount of chirp is reduced during the transmission of the light beam through the optical path.

With external modulation, the light source can be used to generate a continuous beam of light. This arrangement is known in the art as a continuous wave (CW) light source. Since the light source is continuous, the beam of light can be more accurately tuned and can provide a more consistent carrier signal on which information can be encoded. In external modulation systems, the external modulator is responsible for performing the modulation of the light beam by acting as a shutter or iris. In these systems, the external modulator adjusts the amount of light that can pass through an optical path depending on an electric field or current density applied to a material positioned to form a portion of the optical path through which the optical beam passes.

For example, a Mach-Zehnder interferometer can be used as a modulation device. Mach-Zehnder interferometric modulators rely on two physical effects to vary the light intensity. These effects are: a susceptibility of the velocity of light to an electric field, as the light travels through a material, and the concept of optical interference. In a Mach-Zehnder interferometer, an optical splitter divides the incoming light beam into two optical paths and a combiner recombines the beams at the outputs of the optical paths.

An electrical adjustable delay element controls the optical path length in one of the optical paths resulting in a phase difference between the two beams when they are recombined. The adjustable delay element is provided through use of an electric field that is applied to one of the two optical paths in which the split light beams are traveling.

For example, a voltage creates an electric field across the optical path which causes the light beam traveling through the optical path to either be in phase or out of phase with the light beam traveling in the other optical path. When the light beams are recombined, the phases of the light beams can: cancel each other out, subtract from each other, or add together. This results in the light being passed through the modulator at various intensities.

In this way, the light beam can be encoded with information as a series of changes in intensity for transmitting analog information or as on/off pulses of light for transmitting digital information. As stated above, this optical beam, having information encoded therein, can then be used to communicate the encoded information through an optical fiber or other suitable media. Due to the complexities of adjusting one optical beam and combining it with the other optical beam to create the desired signal intensity, phase adjustment modulators, such as the Mach-Zehnder interferometer, work well in applications where the conditions of the system, such as temperature, pressure, humidity, and the like, are static.

Another type of external modulator is an electroabsorption modulator (EAM). In EAMs, light intensity is regulated via electric field controlled absorption. That is, a material that can absorb light is used to form a portion of the optical path. The amount of light absorbed by the material as the light passes through the material can be controlled by an electric field, applied across the optical path.

EAMs have been used in optical communication systems for their small size, low electrical dissipation, low chirp, and high bandwidth, among other advantages. EAMs can be manufactured as an integrated unit with other optical components such as semiconductor lasers, laser diodes, semiconductor optical amplifiers, mode transformers, and attenuators.

EAMs include devices constructed from semiconductor materials which exhibit an electroabsorption effect such as, the Franz-Keldysh effect, the quantum confined Stark effect, or the Wannier-Stark effect, among others. Examples of semiconductor materials that exhibit such effects include, but are not limited to, GaAs, InGaAs, InGaAsP, InP, InGaAlAs, GaAlAs, and InAlAs, as such materials are known to those skilled in the art. These examples of semiconductor materials can be used in various forms to construct an EAM. Construction methods using the above described materials are known to those skilled in the art.

To control the transmission of the optical beam, a voltage is typically applied to the device through electrode contacts to a p-n, n-i-n, or p-i-n junction, as such are known in the art, and to set up an electric field within the optical path. The bandgap energy of the optical path semiconductor material of the EAM is greater than the photon energy of the light to be modulated. The light, therefore, propagates through the device in the absence of the applied voltage. However, when a sufficient voltage is applied across the optical path, the material becomes increasingly opaque to the transmission of the light and the intensity of the optical beam is reduced and, in some EAM devices, can be completely blocked.

A bias voltage can be used to provide a composite voltage value (i.e., the voltage of the information to be encoded and a bias voltage) which allows for the optimum encoding of the information in the optical transmission system. Often the bias is applied to the same port on the EAM as the information to be encoded.

However, in some optical transmission system applications, the systems also have difficulty consistently providing transmission due to the properties of the optical path material used in the EAM that change with temperature such as: bandgap, refractive index, and thermal conductivity, as such characteristics are known and understood in art.

For example, in some military applications, optical transmission systems can be exposed to temperatures ranging from −40 to +85 degrees Celsius. In these situations, since a change in temperature can change the characteristics of the electroabsorption material, a static modulating system will not be capable of adjusting to the change in such characteristics. In these instances, this static modulation will produce distortion in the light signal and/or power loss which can make the information within the signal difficult to decode and can limit the distance that the information can travel.

### SUMMARY OF THE INVENTION

Embodiments of the present invention provide methods, systems, and devices for optical transmission. The embodiments of the present invention actively adjust a bias provided to an EAM to reduce or eliminate the occurrence of a harmonic, such as a second or third order harmonic, produced in connection with the encoding process. An example of one method embodiment includes modulating an optical beam to encode information through use of an EAM, monitoring the encoded optical beam to measure a harmonic value, and upon detection of the harmonic value, adjusting an electrical input provided to the EAM based upon the measured harmonic value.

Method embodiments may also include sampling the encoded optical beam to measure the harmonic. For example, the sampling of the encoded optical beam may be accomplished with a photoreceiver. In various embodiments, the method may also include splitting the encoded optical beam to provide a sample signal and measuring the harmonic of the sample signal.

The harmonic value can be measured through use of a pilot signal. For example, method embodiments may also include: receiving a pilot signal with the electroabsorption modulator, encoding the pilot signal onto an output optical signal, and adjusting the electrical input based upon a harmonic produced by the encoding of the pilot signal.

In another method embodiment, information may be encoded onto an input optical beam to create an encoded output optical beam. The output optical beam from the EAM may be measured to determine the magnitude of a harmonic and a correlation between the harmonic and the electrical input can be tracked to determine an electrical input value that reduces the magnitude of the harmonic. The electrical input to the EAM can be adjusted, based upon the correlation between the harmonic and the electrical input, to maintain the harmonic in an output optical beam of the EAM.

Method embodiments may also include measuring the output optical beam to determine the magnitude of a harmonic produced by encoding a pilot signal on the EAM. The pilot signal may have a frequency that is outside a signal band range of an information signal encoded onto the output optical beam. The electrical input may be adjusted to reduce or to minimize the harmonic based upon the sampled harmonic.

For example, method embodiments may also include adjusting the electrical input within a set of voltages corresponding to a range of harmonic values around a minimum harmonic value. Method embodiments may also include tracking a correlation of the harmonic and the voltage level of the electrical input to determine a voltage input level that correlates to a lowest occurrence of the harmonic. An adjusted biased electrical input to the input optical beam can be applied based upon the determined electrical input level that correlates to the lowest occurrence of the harmonic. Method embodiments may also include adjusting the biased electrical input to limit the harmonic to a percentage of a lowest occurrence of the harmonic. For example, various embodiments may limit the harmonic to 1%, 5%, or 10% of the lowest occurrence of the harmonic. However, the embodiments of the present invention are not limited to the use of a percentage or to the exemplary percentages provided.

The embodiments of the present invention also include optical transmission circuit embodiments. For example, one such circuit embodiment includes an EAM having a number of ports for transmitting and receiving optical and/or electrical signals. For example, in one embodiment the circuit includes an input optical beam port to receive an input optical beam, an information signal port to receive an information signal for encoding information onto the input optical beam, an electrical input port to receive an electrical input biased to a selected voltage level, and an output optical beam port. The embodiment also may include an adjustment module to adjust the electrical input to reduce the harmonic in the output optical beam of the EAM.

The optical transmission circuit embodiments may also be operable to track a correlation of the harmonic and the voltage level of the electrical input to determine an electrical input level that correlates to a lowest occurrence of the harmonic. Optical transmission circuit embodiments may also include an adjustment module operable to adjust the electrical input based upon changes in ambient temperature, changes in device generated temperature, or other changes affecting the signal intensity of the system, such as pressure, humidity, and the like.

The optical transmission circuit embodiments may also include an adjustment module operable to adjust the electrical input in greater amounts as the harmonic trends away from a lowest occurrence of the harmonic. In various embodiments, the adjustment module may also be operable to adjust the electrical input in lesser amounts as the harmonic trends toward a lowest occurrence of the harmonic.

The embodiments of the present invention also include embodiments of optical transmission systems. For example, in one embodiment the system includes an EAM configured to encode information in an optical beam and to modulate an optical beam with an electrical input. This exemplary system embodiment also includes a monitoring component configured to measure a harmonic value and to calculate an electrical input, to be applied to the optical beam via the EAM, based upon the measured harmonic value.

The optical transmission system embodiments may also include a monitoring component that is a signal processing card. Embodiments of an optical transmission system may also include a photoreceiver positioned to receive an output optical beam from the EAM. An optical splitter may be used to split the output optical beam and to direct a sample signal to the photoreceiver.

Circuit embodiments can also include a photoreceiver for sampling the harmonic of an output optical beam from the output optical beam port. Embodiments can also include an adjustment module to adjust the voltage input to reduce the harmonic in the output optical beam of the EAM.

The present invention also includes a number of optical transmission system embodiments. Various system embodiments include a light source, an electrical information source, an electrical source, an electroabsorption modulator, and a photoreceiver. System embodiments are also designed to determine a voltage input to be applied to the electrical input port of the EAM based on the harmonic.

In various embodiments, the light source may be provided for generating an optical signal. The electrical information source may be provided for generating an information signal. The power source may be provided to generate an electrical input.

In such embodiments, the EAM may include an input optical beam port, an electrical information signal port, an electrical input port, and an output optical beam port. The input optical beam port receives the optical beam generated by the light source. The electrical information signal port is provided to receive the information signal for encoding information into the input optical signal. The electrical input port receives the voltage input of a selected voltage level generated by the power source.

The output optical beam port provides a port for transmitting the output optical beam to other devices. In such embodiments, the photoreceiver can be used to sample the harmonic of an output optical beam from the output optical beam port.

The embodiments of the present invention provide methods, devices, and systems that can be configured for us in static and non-static environments due to the periodic adjustment of the bias voltage applied to the EAM.

### BRIEF DESCRIPTION OF THE DRAWINGS

FIG. 1 is an embodiment of an optical transmission system.

FIG. 2 is an example of the correlation between the bias of the output optical beam and a harmonic.

FIG. 3 illustrates another method embodiment of transmitting an optical beam.

### DETAILED DESCRIPTION

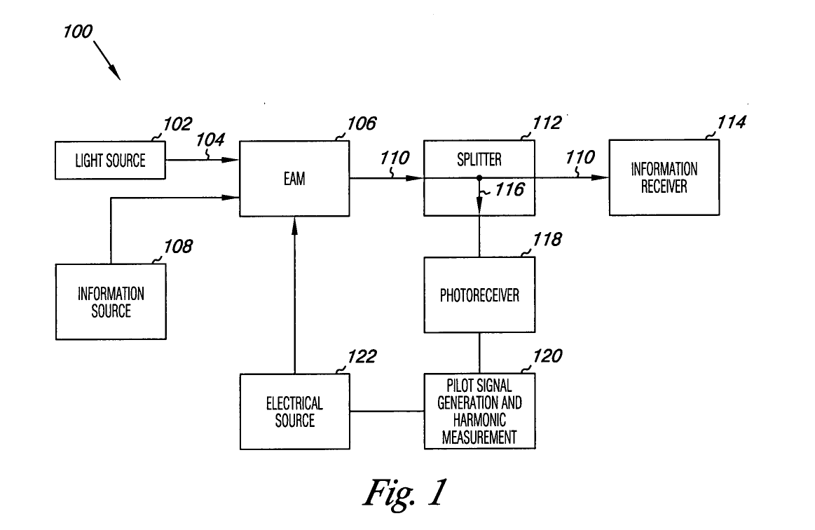

Embodiments of the present invention include methods, systems, and devices for transmitting information encoded in an optical beam. FIG. 1 is an embodiment of an optical transmission system 100 including a light source 102, an input optical beam 104, an EAM 106, an information source 108, an output optical beam 110, and an information receiver 114. Although shown in FIG. 1 as a variety of individual components, a number of the components shown can be integrated into a single unit. For example, the light source 102, EAM 106, optical splitter 112, and photoreceiver 118 can be fabricated on a single substrate or in a single module.

In the embodiment shown in FIG. 1, the light source 102 is used to generate an input optical beam of light 104 that is provided to the EAM 106. As described above, the information is encoded as the EAM 106 varies the passage of the input optical beam 104 (e.g., like a shutter or iris as described above) in a manner that replicates the varying intensity of the information provided by the information source 108. The variance of the input optical beam 104 by the EAM 106 transforms the beam 104 into an encoded output optical beam 110. Once encoded, the varying intensity of the encoded optical beam 110 can be decoded by a decoder at the receiving end of the optical link, such as at the information receiver 114, thereby allowing the decoder to replicate the information from the information source 108 at the receiving end of the communication path.

Those of ordinary skill in the art will understand that any light source can be used with the various embodiments of the present invention. For example, light sources can include lasers, lamps, and other conventional light sources. Examples of lasers include gas lasers, such as He—Ne lasers, solid state lasers, and semiconductor lasers, such as laser diodes, among others. Examples of lamps include light emitting diodes, incandescent lamps, and fluorescent lamps, to name a few.

Additionally, since a variety of light sources can be used in the various embodiments of the invention, the light beam 104 can be any optical beam in the electromagnetic spectrum, and can include single or multiple wavelengths within the spectrum. The portion of the electromagnetic spectrum generally used for optical communication includes wavelengths from approximately 600 nm to 1800 nm; however, the embodiments of the invention are not so limited.

One example of a light source for use in embodiments of the present invention includes a Distributed Feedback (DFB) laser that provides a continuous wave (CW) in the wavelength range of between 1200 and 1700 nm. In some embodiments, such light sources can be integrated on a single semiconductor chip, such as for example, on an InGaAsP, p-i-n type semi-conductor, with an EAM, such as an EAM utilizing the quantum confined Stark effect. Such an EAM can, for example, have an upper limit voltage of approximately 3V to perform the encoding with a bias of approximately 1 to 2 volts.

In various embodiments, the light beam can include wavelengths from various portions of the electromagnetic spectrum. For example, one or more wavelengths can be included from the visible portion of the electromagnetic spectrum and/or the beam can also include wavelengths from the ultraviolet or infrared portions of the electromagnetic spectrum, among other portions therein.

In the embodiment shown in FIG. 1, in order to encode the information, the information to be transmitted is provided to the EAM by an information source 108. The information can be transmitted to the EAM by in various forms, such as electronically or optically. The EAM 106 receives the information from the information source 108 and varies the intensity of the light beam based upon the received information.

An information source can be any device that can provide information to the EAM. Examples include, but are not limited to, servers and other computing devices that handle information such as telephone conversations, computing data, radar signals, and the like, from devices such as: wired and wireless telephones, cable television devices, handheld devices, laptop computers, desktop computers, computers integrated into vehicles and other machines, terminals, peripheral devices, and the like, and the information can be provided in digital or analog formats.

Information provided by the source can include a variety of different kinds of information, and can include information intended to assess the optical link's ability to reliably transmit information. Embodiments of the invention can be used in a variety of optical transmission applications including, but not limited to, transfer of information between computing devices, communication devices, networks, or other such applications.

Once encoded, the output optical beam 110 carries the information to an information receiver 114. The optical beam can be transmitted between the light source 102 and the information receiver 114 on any of various media known to those of ordinary skill in the art. For example, media such as glass and plastic fibers can be used. The optical beam can also be transmitted through the air via free space transmission as such is known to those of ordinary skill in the art.

Information receivers can be any device capable of receiving the optical information. Examples include, but are not limited to, servers and other computing devices that handle information such as telephone conversations, computing data, radar signals, and the like, from devices such as: wired and wireless telephones, cable television devices, handheld devices, laptop computers, desktop computers, computers integrated into vehicles and other machines, terminals, peripheral devices, and the like.

The information source 108 can provide the information to the EAM 106 in various different modes. For example, those skilled in the art will understand that information can be provided to an EAM via digital signals and analog signals, such forms as electrical, radio frequency, and/or optical signals. The information from the information source 108 is encoded on the output optical beam 110 through use of the EAM 106, as described above. Once the information has been encoded, the optical beam is output as output optical beam 110. EAMs are available from a variety of sources, such as T-Networks of Allentown, Pa., among others.

When the information is encoded into the optical beam by the EAM 106, the modulation of the optical beam produces a number of harmonics within the optical beam. In some cases, these harmonics interfere with the encoded information and thereby make the information difficult to decode and, therefore, difficult to reproduce at the information receiver 114.

In the case of optical communications, the harmonic is often generated in the range of wavelengths used for carrying the encoded information. By reducing or eliminating the occurrence, or magnitude, of the harmonic, the system can potentially operate at its optimum transmission capability.

In a static system, this can be achieved by analyzing the occurrence of the harmonic and adjusting the voltage provided to the EAM for modulating the optical beam to a single voltage value that can be consistently provided to the EAM during encoding. However, in a non-static system, such as a system in a vehicle, the optimum voltage will change based upon temperature of the components, and/or the temperature of the ambient air around the components and as such the static solution to reducing the occurrence of the harmonic is not sufficient for a non-static environment.

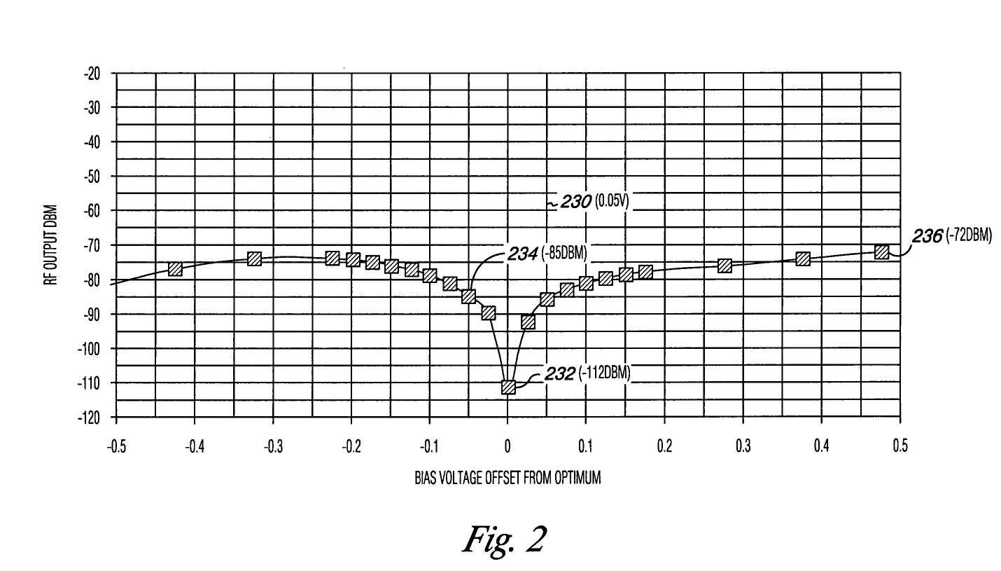

FIG. 2 illustrates an example of the correlation between the harmonic and bias voltage applied to an EAM, such as EAM 106 as shown in FIG. 1. The graph illustrates the harmonic in decibels below one milliwatt (dBm) at various offset bias voltages from an optimum voltage value. The optimum voltage value represents a voltage value at which the occurrence of the harmonic is at a minimum.

As illustrated in FIG. 2, a second order harmonic increases when the bias voltage of the EAM moves away from the value that provides the optimum transmission capability. One of ordinary skill in the art will appreciate upon reading this disclosure that it is desirable to reduce the second order harmonic, for example, for purposes of obtaining the lowest distortion of the information encoded on the output optical signal. Various embodiments of the present invention are intended to reduce variance of the input bias voltage from the optimum value (i.e., lowest occurrence). Additionally, the embodiments of the present invention can be designed to be used with other harmonics, such as third order harmonics, and the like.

For example, in various embodiments, such as that used to provide the data shown in FIG. 2, a small change in the voltage can result in a comparably large change in the second order harmonic. However, the embodiments of the present invention are not limited to application to such “large change” systems. In the exemplary system, shown in FIG. 2, a small change, such as a change of 0.05 volts offset from the optimum bias voltage, can result in a significant change in RF output.

Specifically, the above identified change of 0.05 volts represents a 5% change in the voltage range (e.g., −0.5V to +0.5V) shown in the graph of FIG. 2. That change in bias voltage on the EAM results in a decrease in the amplitude of the information that is carried on the output optical beam and an increase in the amplitude of distortion of the information. As shown in the graph in FIG. 2, the distortion created by the second order harmonic can increase several orders of magnitude based upon a change in the bias voltage.

Specifically, such a change is illustrated in FIG. 2, where a change of 0.05V (indicated by reference number 230 on the graph) from the optimum value of −112 dBm (indicated by reference number 232) results in a change of second order harmonic to −85 dBm (indicated by reference number 234). Since the range of RF output is from between roughly −112 and −72 dBm, (i.e. a change of 40 dB as indicated by reference numbers 232 and 236 on the graph) a change of +27 dB represents a significant increase in the second order harmonic and a correspondingly significant increase in the distortion of the encoded information in the output optical beam. Those skilled in the art will understand that a change of +27 dB represents an increase in the power level of the second order harmonic of almost 1000 times its optimum level (i.e., since every 10 dB change=10 times the power level value, logarithmically).

Accordingly, in such systems, it is advantageous to maintain the electrical input provided by the electrical source at or near the optimum electrical input value. The maintaining of the electrical input at or near its optimum can be accomplished in various ways. For example, the lowest second order harmonic value can be identified and, based upon the measured second order harmonic in the output optical signal, an electrical input can be calculated to reduce or minimize the second order harmonic. For instance, a photoreceiver can sample the second order harmonic value and correlate electrical input values over a period of time and, based upon the lowest second order harmonic value in that time period, an electrical input value can be selected to adjust the output optical beam.

The determination of an electrical input value can be accomplished by selecting the electrical input value used previously to achieve the lowest second harmonic value or by calculating an electrical input value that when added to the input beam value will achieve the output optical beam value that corresponded to the lowest second harmonic value, for example. In various embodiments, second order harmonic values, electrical input values, and/or output optical beam values can be tracked and the electrical input value adjusted, based upon the values that have been tracked, using computer executable instructions (e.g., software and/or firmware, etc.).

Returning to the embodiment of FIG. 1, FIG. 1 illustrates an embodiment of a system for use in a non-static environment. In various embodiments, the output optical beam 110 can be analyzed by one or more of the components of the optical transmission system 100 for signs that the EAM 106 is not operating at its optimum bias. The optimum bias can be defined as the bias applied to the EAM 106 to create the most accurate replication of the information provided by the information source 108 in the output optical beam 110.

In such embodiments, a harmonic can be monitored to identify when the optimum bias is not being achieved. For example, information on the output optical beam or a pilot signal produced by the system during the process of encoding the pilot signal can be monitored for a harmonic. This harmonic can be used to identify when an adjustment to the bias should be made.

A pilot signal can be provided by the information source 108 or the electrical source 122. Additionally, although shown as two separate components, the functionality of the information source 108 and the electrical source 122 can be combined into a single unit. In such embodiments, the multifunction unit can provide the information signal, the pilot signal, and/or the electrical signal to the EAM.

In various embodiments, the pilot signal can be produced in a frequency that is out of the signal band of the information encoded onto the output optical signal. In this way, the pilot signal does not interfere with the transmission of the information and the pilot signal is not distorted or lost in the encoded information. For example, in various embodiments, the encoded information that has been encoded on the output optical signal has a frequency of 50 kHz to 40 GHz. In such cases, a pilot signal can be provided that is outside the one or more frequencies of the encoded information. For example, a pilot signal for such a frequency range can be in the range of 1 to 5 kHz; however, the embodiments of the invention are not limited to use of a pilot signal or to this exemplary pilot signal range.

A photoreceiver can be positioned after the EAM 106 to sample the output optical beam 110, having the pilot signal therein, to identify the harmonic. This can be accomplished, for example, by photoreceiver 1118, shown in FIG. 1.

In some embodiments, the photoreceiver can be positioned to sample the output optical beam 110 directly. However, in the embodiment shown in FIG. 1, an optical splitter 112 is used to create a sample signal 116 of the output optical beam 110 that can be sampled by the photoreceiver 118. One of ordinary skill in the art will understand the manner in which an optical splitter can be used to create a sample signal.

In various embodiments, the sample signal 116 represents a small percentage, typically less than 10% of the output optical beam. Embodiments, however, are not so limited. The use of a sample signal 116 can be used to reduce the potential for distortion of the information encoded on the output optical beam 110, since the output optical beam does not pass through the photoreceiver 118 in such embodiments.

The photoreceiver 118 includes a photodetector. The photodetector converts light into electrical current that can be used to measure the light beam passing through the photodetector. A photodetector takes the energy of a photon from within the light beam that is absorbed by a semiconductor, and, converts the energy into electrical current. Photodetector electrical output, as shown in FIG. 1, can be used to identify the occurrence and magnitude of harmonic distortion that is appearing on the transmitted information.

Photodetectors are available in various types. For example, photodetector types include: Avalanche Photo Diodes (APD) and PIN photodetectors (P-doped, I-intrinsic, N-doped), such as those available from Lightwaves2020 of Milpitas, Calif., among others.

An electrical source 122 is used to add an electrical input in the form of a voltage or current to the EAM 106. In the embodiments shown in FIG. 1, a voltage is used to attempt to bias the optical beam to its best operating point for the transmission of information through the optical path. At this best operating point, the second harmonic produced by all of the information in the output optical beam 110 (i.e., encoded information and pilot signal) has little or no occurrence. Accordingly, in order to find the best bias voltage for signal transmission, the harmonic can be used to identify when the output optical beam is correctly biased by the electrical input.

In order to measure the harmonic, the embodiment shown in FIG. 1 also includes a pilot signal generation and harmonic measurement apparatus 120 (e.g., also referred to herein as an adjustment module). The pilot signal generation and harmonic measurement apparatus 120 can use the measurements taken by the photoreceiver 118 to calculate the electrical input to be provided as a bias to the EAM 106. This information can then be used by the power source 122 to adjust the electrical input provided to the EAM 106.

In various embodiments, pilot signal generation and harmonic measurement apparatus 120 is operable to adjust the electrical input in greater amounts as the harmonic trends away from a lowest occurrence of the harmonic. The pilot signal generation and harmonic measurement apparatus 120 can also be operable to adjust the electrical input in lesser amounts as the harmonic trends toward a lowest occurrence of the harmonic. In this way, the system can more rapidly return to a voltage near the voltage corresponding to the lowest occurrence of the harmonic and, once close, the magnitude of adjustment can be reduced so that the adjustments may not overcompensate for the difference between the optimum voltage and the current voltage.

A pilot signal generation and harmonic measurement apparatus 120 can be purchased from a variety of resources, including OpNext of Eatontown, N.J. As stated above, the functionality of the pilot signal generation and harmonic measurement apparatus 120 can be incorporated into one or more other components of the system, such as the electrical source 122 and/or the photoreceiver 118.

As one of ordinary skill in the art will appreciate, optical signaling systems can include logic circuits, processor(s), and memory in one or more of its components and that computer executable instructions, (e.g., software and/or firrnware) can be used to aid in controlling the functionality of the components of the system. For example, as described in more detail below, the executable instructions can execute to initiate the measurement of the occurrence of the harmonic, calculate the adjustment of the electrical input, store previous electrical inputs and/or harmonic values, and can track the measurements to identify the change in the harmonic and the change in electrical input provided to the EAM 106. Those skilled in the art will also understand that the system can also use hardware to control a number of the functions of the system.

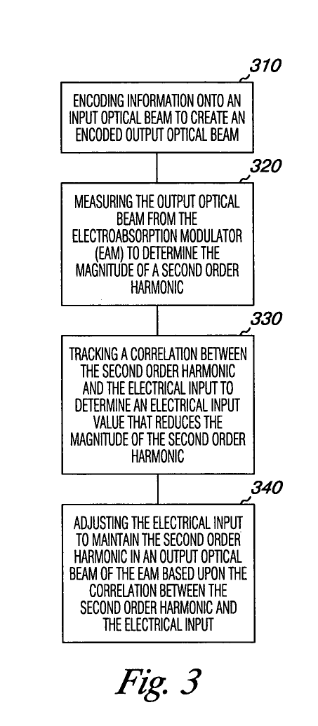

FIG. 3 illustrates a method embodiment of optical transmission. As one of ordinary skill in the art will understand, embodiments can be performed by computer executable instructions as mentioned above that are operable on the systems and devices shown herein or otherwise. The invention, however, is not limited to a particular operating environment or to software written in a particular programming language. Computer executable instructions, including software, firmware, program applications, and/or application modules, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments or elements thereof can occur or be performed at the same point in time.

FIG. 3 illustrates a method embodiment for transmitting an optical beam. The method embodiment includes measuring the output optical beam from the EAM to determine the magnitude of a harmonic at block 310, as the same has been described above. The method embodiment of FIG. 3 also includes encoding information onto an input optical beam to create an encoded output optical beam at block 320. As described herein, the input optical beam can be encoded with the information from an electrical information signal to produce an encoded output optical beam. Additionally, the output optical beam can be biased through use of an electrical input.

At block 330, the method embodiment also includes tracking a correlation between the harmonic and the electrical input to determine an electrical input value that reduces the magnitude of the harmonic. The harmonic can be any of a number of harmonics that are generated from the encoding process including, but not limited to, second and third harmonics and one or more harmonics can be evaluated to determine an electrical input value. Measuring the output optical beam can also include determining the magnitude of a harmonic produced by encoding a pilot signal on the EAM. As discussed above, the pilot signal can have a frequency that is outside a signal band range of an information signal encoded onto the output optical beam.

The method embodiment of FIG. 3 also includes adjusting the electrical input to maintain the harmonic in an output optical beam of the EAM based upon the correlation between the harmonic and the electrical input at block 340.

As stated above, a photoreceiver can be used to sample the optical beam to identify the occurrence of the harmonic. The adjustment module can use the information from the photoreceiver to measure the occurrence of the harmonic. In various embodiments, the photodetector can be part of a photoreceiver that can be used to receive the sample signal therein.

In various embodiments, the correlation of the harmonic and a voltage level of the electrical input can be tracked to determine an electrical input voltage level that correlates to a lowest occurrence of the harmonic. For example, the tracking of the correlation can be accomplished through use of program instructions in software and/or firmware. The program instructions can also allow the voltage level of the electrical input to be adjusted based upon the tracked correlation to reduce or minimize the occurrence of the harmonic.

In some embodiments, in order to adjust the electrical input level, the adjustment can be based upon the determined voltage level that correlates to the lowest occurrence of the harmonic. In this way, the electrical input can be used to reduce or minimize the occurrence of the harmonic in the output optical beam through use of a previously determined electrical input.

In various embodiments, the electrical input can be adjusted periodically to limit the occurrence of the harmonic to within a particular range (e.g., 5%) of the lowest occurrence of the harmonic. The range can be any range suitable for use with an embodiment of the present invention. The periodic adjustment of the electrical input can be accomplished by tracking the lowest occurrence of the harmonic over time and then establishing a threshold, such as 5% above the lowest occurrence or by predetermining a lowest occurrence and setting a threshold based upon the predefined value. The use of a range can provide a mechanism for reducing the occurrence of the harmonic over a period of time.

This reduction of the harmonic can be accomplished, for example, by sampling the output optical beam to measure the harmonic. The sampling can be done through use of a photoreceiver that can be arranged to sample the output optical beam as a whole, or arranged to sample a sample signal of the output optical beam as described above.

In embodiments where a sample signal is to be measured, the sample signal can be created by splitting the output optical beam after it has left the EAM. Those skilled in the art will understand that an optical splitter can create sample signals of various sizes. For example, sample signals can be any percentage, such as 0.1%, 1%, 5%, 10%, etc. of the original output optical beam. Once the sample signal is created, the sample signal can then be analyzed to measure the harmonic by positioning the photoreceiver such that the sample signal passes through the photoreceiver. Sample signals can be analyzed using devices as described above in conjunction with computer executable instructions (e.g., software and/or firmware, etc.) operating thereon or with hardware.

In various method embodiments, the methods can also include receiving a pilot signal with the electroabsorption modulator, encoding the pilot signal onto an output optical signal, and adjusting the electrical input based upon a harmonic produced by the encoding of the pilot signal. In this way, a pilot signal can be used to generate the harmonic and therefore, can produce a harmonic that may be more easily analyzed for determining an electrical input value.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method of transmitting an optical beam, comprising:
modulating an optical beam to encode information through use of an electroabsorption modulator (EAM);
monitoring the encoded optical beam to measure a harmonic value; and
upon detection of the harmonic value, adjusting an electrical input provided to the EAM based upon the measured harmonic value.

2. The method of claim 1, further including sampling the encoded optical beam to measure the harmonic value.

3. The method of claim 2, further including sampling the encoded optical beam with a photoreceiver.

4. The method of claim 1, further including splitting the encoded optical beam to provide a sample signal and measuring the harmonic value of the sample signal.

5. The method of claim 1, wherein the harmonic value is measured for a second order harmonic.

6. The method of claim 1, further including:
encoding a pilot signal onto the optical beam;
monitoring the pilot signal; and
adjusting the electrical input based upon the measured harmonic value detected in the pilot signal.

7. A method for transmitting information in an optical communications system, comprising:
encoding information onto an output optical beam through use of an electroabsorption modulator (EAM);
monitoring the output optical beam from the electroabsorption modulator (EAM) to determine the magnitude of a harmonic;
correlating the magnitude of the harmonic with an optimum electrical signal value to be input to the EAM to reduce the magnitude of the harmonic; and
adjusting an electrical input to the EAM to equal the optimum electrical signal value.

8. The method of claim 7, wherein measuring the output optical beam includes measuring the output optical beam to determine the magnitude of a harmonic produced by encoding a pilot signal on the EAM.

9. The method of claim 8, further including measuring a pilot signal having a frequency that is outside a signal band range of an information signal encoded onto the output optical beam.

10. The method of claim 7, further including sampling the harmonic through use of a photoreceiver.

11. The method of claim 10, further including adjusting the electrical input to minimize the second order harmonic based upon the sampled harmonic.

12. The method of claim 7, wherein adjusting the electrical input includes adjusting the electrical input within a set of voltages corresponding to a range of values around a minimum harmonic value.

13. A computer readable medium having program instructions to cause a device to perform a method, comprising:
modulating an optical beam to encode information through use of an electroabsorption modulator (EAM);
monitoring the encoded optical beam to measure a harmonic value; and
upon detection of the harmonic value, adjusting an electrical input provided to the EAM based upon the measured harmonic value.

14. The computer readable medium of claim 13, further including tracking a correlation of the harmonic value and the voltage level of the electrical input to determine a voltage input level that correlates to a lowest occurrence of the harmonic.

15. The computer readable medium of claim 13, further including applying an adjusted biased electrical input to the input optical beam based upon the determined electrical input level that correlates to the lowest occurrence of the harmonic.

16. The computer readable medium of claim 13, further including adjusting the electrical input to minimize the harmonic.

17. The computer readable medium of claim 13, further including adjusting the biased electrical input to limit the harmonic to within 5% of a lowest occurrence of the harmonic.

18. An optical transmission system, comprising:
an electroabsorption modulator (EAM) configured to encode information in an optical beam and to modulate the optical beam according to an electrical input; and
a monitoring component configured to measure a harmonic value in the encoded optical beam and to calculate an electrical input, to be applied to the EAM so as to reduce the measured harmonic value.

19. The optical transmission system of claim 18, wherein the monitoring component is configured to measure a harmonic value of a second order harmonic.

20. The optical transmission system of claim 18, wherein the monitoring component is a signal processing card.

21. The optical transmission system of claim 18, wherein a photoreceiver is positioned to receive an output optical beam from the EAM.

22. The optical transmission system of claim 21, further including an optical splitter to split the output optical beam and to direct a sample signal to the photoreceiver.

23. The optical transmission system of claim 22, wherein the sample signal is 1% of the output optical beam.

24. The optical transmission system of claim 23, wherein the photoreceiver is positioned to receive the sample signal.

25. The optical transmission system of claim 18, further including an adjustment module operable to adjust the electrical input based upon changes in ambient temperature.

26. The optical transmission system of claim 18, further including an adjustment module operable to adjust the electrical input based upon changes in device generated temperature.

27. The optical transmission system of claim 18, further including an adjustment module operable to adjust the electrical input in greater amounts as the harmonic trends away from a lowest occurrence of the harmonic.

28. The optical transmission system of claim 18, further including an adjustment module operable to adjust the electrical input in lesser amounts as the harmonic trends toward a lowest occurrence of the harmonic.

29. The optical transmission system of claim 18, further including an optical source for providing the optical beam to the EAM.
